(19) United States
(12) Patent Application Publication
(10) Pub. No.: US 2026/0186717 A1
(43) Pub. Date: Jul. 2, 2026

(54) NON-TRANSITORY COMPUTER-READABLE STORAGE MEDIUM STORING PRINT CONTROL PROGRAM, INFORMATION PROCESSING APPARATUS, AND INFORMATION PROCESSING METHOD

(71) Applicant: SEIKO EPSON CORPORATION, Tokyo (JP)

(72) Inventor: Ryotaro KUBO, Minamiminowa-machi, Nagano (JP)

(21) Appl. No.: 19/432,281

(22) Filed: Dec. 24, 2025

(30) Foreign Application Priority Data
Dec. 26, 2024 (JP) 2024-230026

(51) Int. Cl. G06F 3/12; G06Q 30/0601

(52) U.S. Cl. CPC G06F 3/1228; G06F 3/1203; G06F 3/1231; G06Q 30/0624

(57) ABSTRACT

A non-transitory computer-readable storage medium storing a print control program according to an aspect of the present disclosure stores a print control program for extending a general-purpose printer driver. The print control program causes a computer to execute first acquisition processing, second acquisition processing, third acquisition processing, and display processing. In the first acquisition processing, apparatus information of a printer is acquired from the printer. In the second acquisition processing, at least either region information or language information is acquired from an operating system (OS). In the third acquisition processing, the apparatus information and at least either the region information or the language information are transmitted to a server connected to the computer, and vendor guide information regarding a vendor of the printer is acquired from the server. In the display processing, the vendor guide information is displayed.

The present application is based on, and claims priority from JP Application Serial Number 2024-230026, filed December 26, 2024, the disclosure of which is hereby incorporated by reference herein in its entirety.

### BACKGROUND

### 1. Technical Field

The present disclosure relates to a non-transitory computer-readable storage medium storing a print control program, an information processing apparatus, and an information processing method.

### 2. Related Art

JP-A-2016-53949 discloses a technique for displaying various kinds of information related to an image forming apparatus such as a printer when printing is performed by the image forming apparatus.

Incidentally, general-purpose printer drivers such as operating system (OS) standard printer drivers do not support display of detailed information. Therefore, it is desirable to develop a technique enabling detailed information to be displayed in environments in which print processing using a general-purpose printer driver is performed. Note that the technique described in JP-A-2016-53949 is not a technique capable of solving such a problem.

### SUMMARY

A non-transitory computer-readable storage medium storing a print control program according to an aspect of the present disclosure stores a print control program for extending a general-purpose printer driver. The print control program causes a computer to execute: first acquisition processing of acquiring, from a printer, apparatus information of the printer; second acquisition processing of acquiring, from an operating system, at least either region information or language information; third acquisition processing of transmitting the apparatus information and at least either the region information or the language information to a server connected to the computer and acquiring, from the server, vendor guide information regarding a vendor of the printer; and display processing of displaying the vendor guide information.

An information processing apparatus according to an aspect of the present disclosure includes: a general-purpose printer driver that is standard with an operating system; a first acquisition processing section that acquires, from a printer, apparatus information of the printer; a second acquisition processing section that acquires, from the operating system, at least either region information or language information; a third acquisition processing section that transmits the apparatus information and at least either the region information or the language information to a server connected to the information processing apparatus and acquires, from the server, vendor guide information regarding a vendor of the printer; and a display processing section that displays the vendor guide information.

An information processing method according to an aspect of the present disclosure includes causing a computer to execute: first acquisition processing of acquiring, from a printer, apparatus information of the printer; second acquisition processing of acquiring at least either region information or language information from an operating system in which a general-purpose printer driver is included or to which the general-purpose printer driver is attached; third acquisition processing of transmitting the apparatus information and at least either the region information or the language information to a server connected to the computer and acquiring, from the server, vendor guide information regarding a vendor of the printer; and display processing of displaying the vendor guide information.

### BRIEF DESCRIPTION OF THE DRAWINGS

FIG. 1 is a block diagram illustrating a configuration example of a printing system including an information processing apparatus according to a first embodiment.

FIG. 2 is a flowchart for explaining a processing example of the information processing apparatus in the printing system of FIG. 1.

FIG. 3 is a sequence diagram for explaining a processing example in the printing system of FIG. 1.

FIG. 4 is a sequence diagram for explaining a processing example subsequent to FIG. 3.

FIG. 5 is a sequence diagram for explaining another processing example subsequent to FIG. 3.

FIG. 6 is a diagram illustrating an example of a user interface image displayed in the processing example of FIG. 3.

FIG. 7 is a sequence diagram for explaining another processing example in a printing system including an information processing apparatus according to a second embodiment.

FIG. 8 is a sequence diagram for explaining a processing example subsequent to FIG. 7.

FIG. 9 is a diagram illustrating an example of a user interface image displayed in the processing example of FIG. 8.

FIG. 10 is a sequence diagram for explaining another processing example subsequent to FIG. 7.

FIG. 11 is a diagram illustrating an example of a hardware configuration of an apparatus.

### DESCRIPTION OF EMBODIMENTS

Hereinafter, embodiments of the present disclosure will be described with reference to the drawings. Note that the drawings are merely examples for explaining the embodiments of the present disclosure. Furthermore, not all components described in the embodiments of the present disclosure are necessarily essential configuration requirements in the present disclosure.

### First Embodiment

### Configuration Example of System

An information processing apparatus according to the present embodiment is an apparatus that is connected to a printer and a server and is capable of providing an instruction for printing to the printer and causing information from the server to be displayed. The information processing apparatus constitutes a printing system together with the printer and the server. Since the printing system performs information processing including display, the printing system may be referred to as an information display system, an information processing system, or the like.

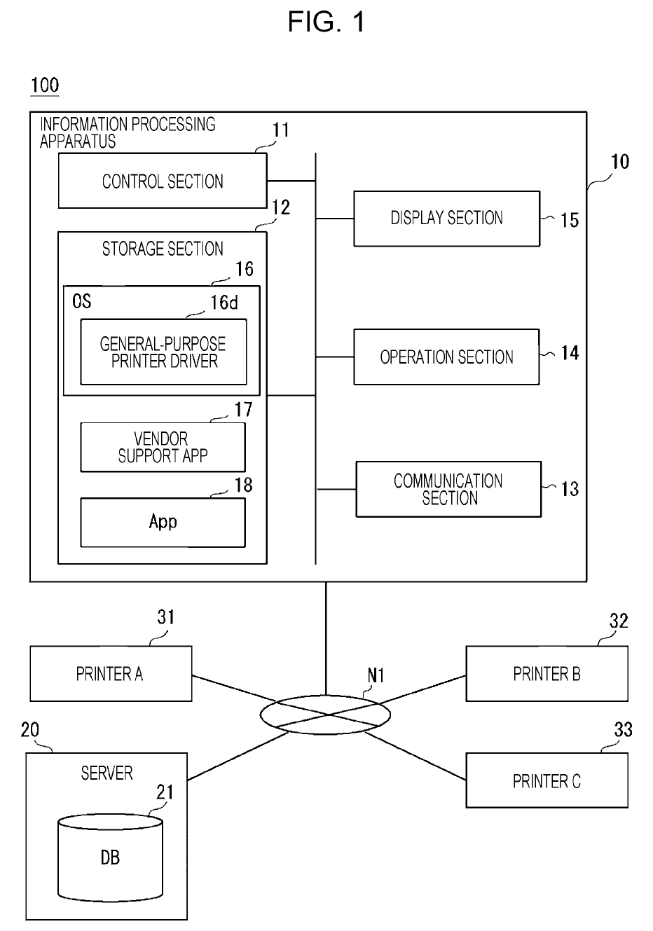

Hereinafter, a configuration example of the printing system including the information processing apparatus according to the present embodiment will be described with reference to FIG. 1. FIG. 1 is a block diagram illustrating the configuration example of the printing system according to the present embodiment.

As illustrated in FIG. 1, a printing system 100 according to the present embodiment can include an information processing apparatus 10, a server 20, a printer A(31), a printer B(32), and a printer C(33).

The information processing apparatus 10 is a terminal apparatus having a communication function, such as a personal computer (PC), a smartphone, or a tablet terminal, and can be used by a user who desires to perform printing. The information processing apparatus 10 is connected to the printer A(31), the printer B(32), and the printer C(33) via a network N1 for processing of transmitting a print request and the like. Although not illustrated in the drawing, the printing system 100 can include a plurality of information processing apparatuses 10.

In a case where print data is received, all of the printer A(31), the printer B(32), and the printer C(33) can perform printing on a medium. Each printer produces a printed matter by performing printing.

The printing system 100 can perform printing by a printer selected from among the printer A(31), the printer B(32), and the printer C(33) by a user operation from the information processing apparatus 10.

In addition, although the printing system 100 is described on the assumption that the printing system 100 has a configuration including the three printers for convenience, it is only necessary for at least one printer to be included. Furthermore, each printer can also be referred to as a printing apparatus, an image forming apparatus, or a multifunction apparatus. Although it is only necessary for each printer to be an apparatus having a communication function and a printing function, each printer may be a multifunction apparatus having other functions such as a scanning function, a copying function, and a facsimile function. Note that the copying function is implemented by the scanning function and the printing function. In addition, a printing method in each printer is not limited, and various printing methods such as an ink jet printing method and a laser printing method, for example, can be applied.

In addition, the information processing apparatus 10 is connected to the server 20 via the network N1 for processing of acquiring vendor guide information, which will be described later, regarding the printer A(31), the printer B(32), and the printer C(33).

The server 20 is a server computer and can be configured to include, for example, an arithmetic processing device, a working memory, and a storage device that stores a control program, parameters, and the like in any cases, although description of detailed configurations is omitted. The storage device can store a database (DB) 21. The DB 21 stores the vendor guide information in association with apparatus information and the like of each printer, and a detailed example thereof will be described when the information processing apparatus 10 is described. Note that the server 20 may be a cloud server.

Hereinafter, a configuration example of the information processing apparatus 10 will be described in detail. Note that description of configuration examples of the server 20 and each printer will be omitted.

### Configuration Example of Information Processing Apparatus 10

As illustrated in FIG. 1, the information processing apparatus 10 can include a control section 11, a storage section 12, a communication section 13, an operation section 14, and a display section 15.

The control section 11 controls the entire information processing apparatus 10. The control section 11 can be configured to include, for example, an arithmetic processing device, a working memory, and a storage device that stores a control program, parameters, and the like. The arithmetic processing device can be a central processing unit (CPU), a graphics processing unit (GPU), or the like. The control section 11 can also be configured as a system on a chip (SoC). As can be seen from these examples, the control section 11 can be configured to store the control program in an executable state. However, the control section 11 can also be configured to store a part of the control program as a circuit configuration such as a field-programmable gate array (FPGA) or can be configured as a dedicated circuit.

The above-described control program can include a program for the arithmetic processing device to execute processing related to printing in cooperation with the storage section 12, the communication section 13, the operation section 14, and the display section 15. The above-described control program can include an operating system (OS) 16. Since the OS 16 is an OS installed in the information processing apparatus 10, the OS is of a type corresponding to the model or the like of the information processing apparatus 10. The above-described control program can include a web browser inside the OS 16 or outside the OS 16. Although an example in which at least a part of the control program is stored in the storage section 12 provided separately from the control section 11 will be described in FIG. 1, the storage section 12 may be a part of a storage device in the control section 11. In other words, the storage section 12 can also be regarded as a part of the control section 11.

The storage section 12 is, for example, a storage device such as a hard disk drive, a solid state drive, or another memory. As a part of the control program, a general-purpose printer driver 16d and a vendor support application program 17 are stored in the storage section 12 in a state of being executable by the control section 11. The general- purpose printer driver 16d can be part of the OS 16. In addition, an application program 18 for generating and editing a document file or the like is stored as a part of the control program in the storage section 12 in a state of being executable by the control section 11. In FIG. 1 and the following description, the vendor support application program will be abbreviated as a vendor support app, and the application program will be abbreviated as an app. Furthermore, the storage section 12 can store various kinds of data such as data of a file to be printed.

The communication section 13 is a section that communicates with external apparatuses in a wireless or wired manner via the network N1 in accordance with various mobile communication standards and predetermined communication standards such as the Wi-Fi (registered trademark) standard. In the printing system 100, the external apparatuses include the server 20, the printer A(31), the printer B(32), and the printer C(33). The communication section 13 can be configured by one or more communication interfaces capable of performing such communication. The communication interfaces are, for example, antennas or cable connectors. The network N1 is typically a local area network (LAN). Note that although the example in which the printing system 100 connects each apparatus via one network N1 is described for simple description, a network through which communication with the server 20 is performed and a network through which communication with each printer is performed may be different from each other.

The operation section 14 is a section that receives an operation performed by a user of the information processing apparatus 10 and can also be referred to as an operation receiving section. The operation section 14 can be implemented by, for example, any one or more of a physical button, a touch panel mounted on the display section 15, a pointing device, and a keyboard. In a configuration in which the operation section 14 includes a touch panel, the display section 15 and the touch panel may be collectively referred to as an operation panel of the information processing apparatus 10.

The display section 15 is a section for displaying a user interface (UI) image for operating the information processing apparatus 10 and is configured by a display device such as a liquid crystal display or an organic electroluminescence display, for example. Note that the display section 15 can be configured to include a display and a drive circuit for driving the display.

The general-purpose printer driver 16d will be described. The general-purpose printer driver 16d is an OS standard printer driver included in the OS 16 or attached to the OS 16 included in the control program. The general-purpose printer driver 16d can be a program capable of controlling various types of printers and causing the printers to execute printing. Note that the general-purpose printer driver 16d can also be referred to as an OS general-purpose printing program or a general-purpose printing program.

The general-purpose printer driver 16d is a driver that uses a general-purpose protocol for searching for a printer and performing printing. The general-purpose printer driver 16d uses mDNS/DNS-SD for searching for a printer and uses IPP for performing printing by the printer, for example. Here, DNS is an abbreviation for Domain Name System. mDNS is an abbreviation for multicast DNS. DNS-SD is an abbreviation for DNS Service Discovery. IPP is an abbreviation for Internet Printing Protocol.

As can be seen from this example as well, the general-purpose printer driver 16d can be, for example, an IPP Class driver. IPP is an example of a standard protocol for controlling printer management and printing. IPP acquires and controls information regarding the printers by POST request and response of Hyper Text Transfer Protocol (HTTP). IPP enables printer setting and printer state acquisition. Here, secure communication can be performed by using HTTP Secure (HTTPS) instead of HTTP.

The vendor support app 17 will be described. The vendor support app 17 is an application program that supports the general-purpose printer driver 16d and is used to extend functions of the general-purpose printer driver 16d. Therefore, the general-purpose printer driver 16d can have functions of activating the vendor support app 17 and transmitting a print job to the vendor support app 17. The vendor support app 17 can be, for example, a Print Support Application (PSA). Note that one print job indicates an instruction for a series of operations for printing one or more printed matters and includes print data and print settings. In a case where a plurality of printed matters are printed, one print job can indicate an instruction for a series of operations for printing printed matters with the same print content.

The vendor support app 17 can be a program for supporting the general-purpose printer driver 16d and causing a computer to execute print control suitable for performance of a target printer, that is, print control for supporting functions unique to the printer. The computer mentioned here indicates the information processing apparatus 10 or the control section 11. In a case where a print job is acquired from the general-purpose printer driver 16d, the vendor support app 17 can convert the print job so that printing using functions unique to the designated printer can be executed by the printer.

In the present embodiment, the vendor support app 17 has a function of displaying vendor guide information as an extended function. The vendor support app 17 is an application program provided by a vendor of the printer or the like. The vendor support app 17 can be provided to the user of the information processing apparatus 10 by being released to the public in an application store or the like of a provider of the OS, for example. Alternatively, the vendor support app 17 can be provided to the user by being included in or attached to the OS. The vendor support app 17 may be activated by the general-purpose printer driver 16d or may be activated without using the general-purpose printer driver 16d.

The vendor support app 17 includes a print control program, which will be described next. In other words, this print control program can also be implemented as, for example, a PSA. The print control program is a print control program that extends the general-purpose printer driver 16d and is a program that causes the computer to execute first acquisition processing, second acquisition processing, third acquisition processing, and display processing as will be described next. The computer mentioned here also indicates the information processing apparatus 10 or the control section 11. Although each process will be described below using an example in which a printer which is a target of a print instruction is the printer A(31), the same applies to the printer B(32) and the printer C(33).

The first acquisition processing is processing of acquiring apparatus information of the printer A(31) from the printer A(31). Since the apparatus information is information of a main body of the printer A(31), the apparatus information may be referred to as printer main body information. It is possible to state that the information processing apparatus 10 includes a first acquisition processing section that performs such first acquisition processing. The first acquisition processing section is exemplified by the control section 11 and the vendor support app 17.

However, the first acquisition processing may be processing of acquiring the apparatus information via the general-purpose printer driver 16d depending on functions of the general-purpose printer driver 16d. This acquisition is executed by inter-process communication between the general- purpose printer driver 16d and the vendor support app 17. The general-purpose printer driver 16d can acquire the apparatus information from the printer A(31) and pass the apparatus information to the vendor support app 17. In other words, the vendor support app 17 can acquire the apparatus information of the printer A(31) via the general-purpose printer driver 16d.

The second acquisition processing is processing of acquiring at least either region information or language information from the OS 16. The following description will be given by referring to at least either the region information or the language information to be acquired in the second acquisition processing as first information. It is possible to state that the information processing apparatus 10 includes a second acquisition processing section that performs such second acquisition processing. The second acquisition processing section is exemplified by the control section 11 and the vendor support app 17. However, the second acquisition processing may be processing of acquiring the apparatus information via the general-purpose printer driver 16d depending on functions of the general-purpose printer driver 16d.

The third acquisition processing is processing of transmitting the apparatus information acquired in the first acquisition processing and the first information acquired in the second acquisition processing to the server 20 connected to the information processing apparatus 10 and acquiring vendor guide information regarding the vendor of the printer A(31) from the server 20. It is possible to state that the information processing apparatus 10 includes a third acquisition processing section that performs such third acquisition processing. The third acquisition processing section is exemplified by the control section 11 and the vendor support app 17.

The vendor guide information can be, for example, at least one kind of information regarding subscriptions, new model information, ink purchase site information, and repair center information. Hereinafter, the information regarding subscriptions will be abbreviated as subscription information. In the third acquisition processing, it is only necessary for the server 20 to return the vendor guide information with reference to the DB 21 based on the received apparatus information and first information. It is only necessary for the DB 21 to store the vendor guide information in association with the apparatus information of each printer and the first information.

In a case where only language information is transmitted to the server 20 as the first information in the third acquisition processing, the vendor guide information written in a language indicated by the language information is acquired as the vendor guide information. In a case where only the region information is transmitted to the server 20 as the first information in the third acquisition processing, the vendor guide information that matches a region indicated by the region information is acquired as the vendor guide information. The vendor information that matches the region indicated by the region information can indicate, for example, in a case where the vendor guide information includes repair center information, information indicating a repair center in the region.

The display processing is processing of displaying the vendor guide information acquired in the third acquisition processing. The display destination is the display section 15. It is possible to state that the information processing apparatus 10 includes a display processing section that performs such display processing. The display processing section is exemplified by the control section 11, the vendor support app 17, and the display section 15.

The print control program according to the present embodiment has been mainly described above. In other words, it is possible to provide in the present embodiment an information processing method including the above-described first acquisition processing, second acquisition processing, third acquisition processing, and display processing which are executed by the computer as extended functions of the general-purpose printer driver 16d.

### Outline of Processing Example of Information Processing Apparatus 10

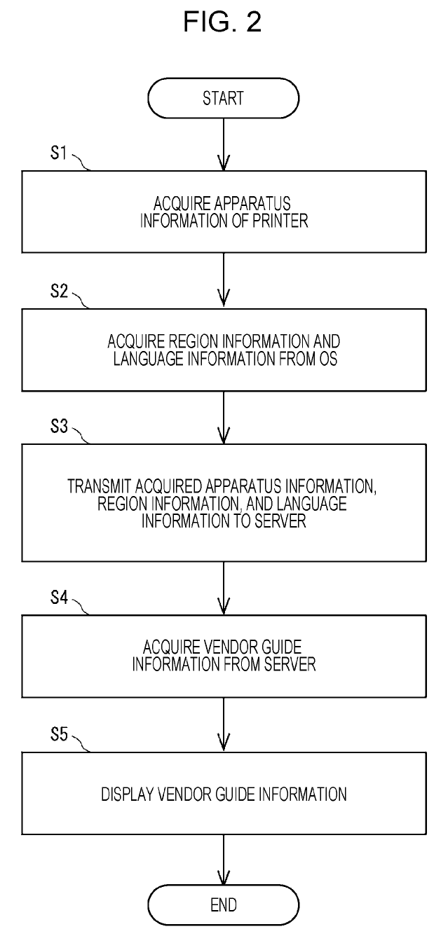

An outline of a processing example of the information processing apparatus 10 will be briefly described with reference to FIG. 2. FIG. 2 is a flowchart for explaining a processing example of the information processing apparatus 10.

First, the information processing apparatus 10 acquires, from the printer A(31), apparatus information of the printer A(31) (Step S1). Next, the information processing apparatus 10 acquires at least either region information or language information from the OS 16 in which the general-purpose printer driver 16d is included or to which the general-purpose printer driver 16d is attached (Step S2). Hereinafter, an example in which both the region information and the language information are acquired will be described. Note that Step S1 and Step S2 may be performed in any order.

Next, the information processing apparatus 10 transmits, to the server 20, the apparatus information acquired in Step S1 and the region information and the language information (Step S3). In response to this, the server 20 transmits vendor guide information regarding the vendor of the printer A(31) to the information processing apparatus 10, and the information processing apparatus 10 thus acquires the vendor guide information from the server 20 (Step S4). Then, the information processing apparatus 10 displays the acquired vendor guide information on the display section 15 (Step S5) and ends the processing.

### Specific Processing Example of Printing System 100

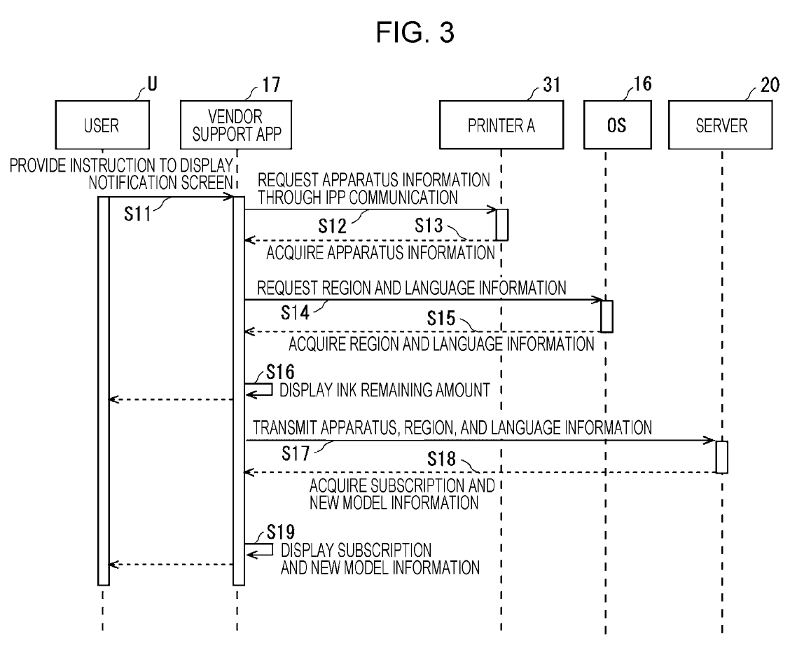

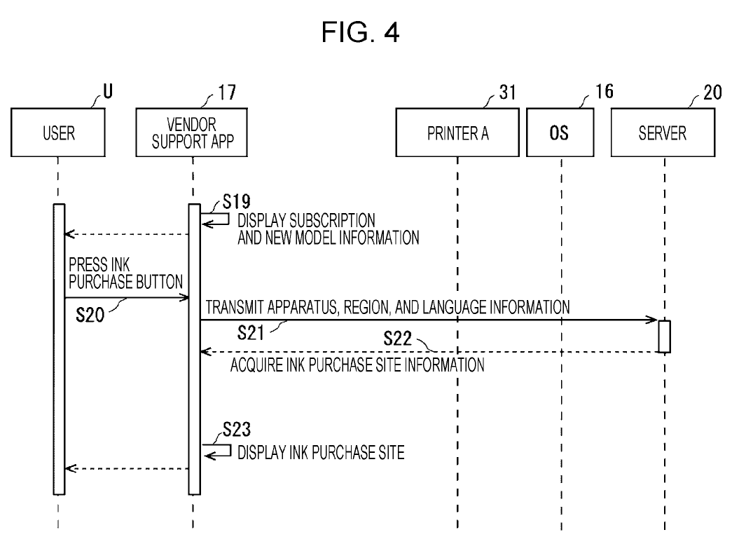

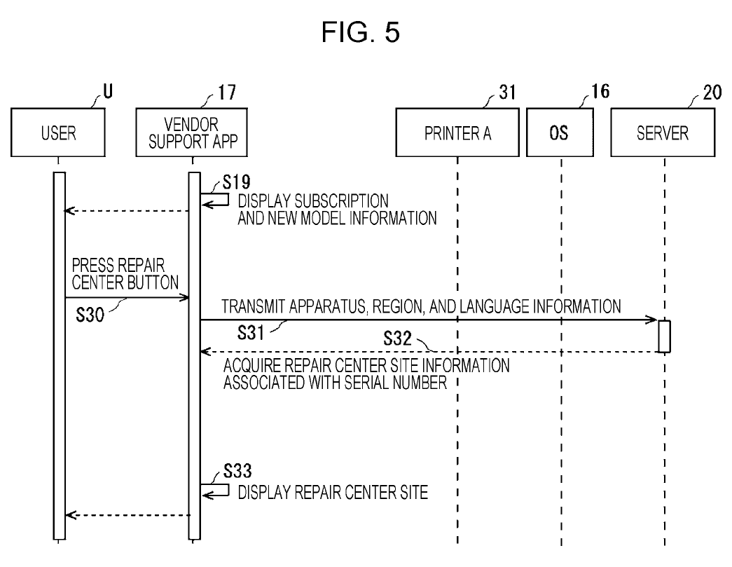

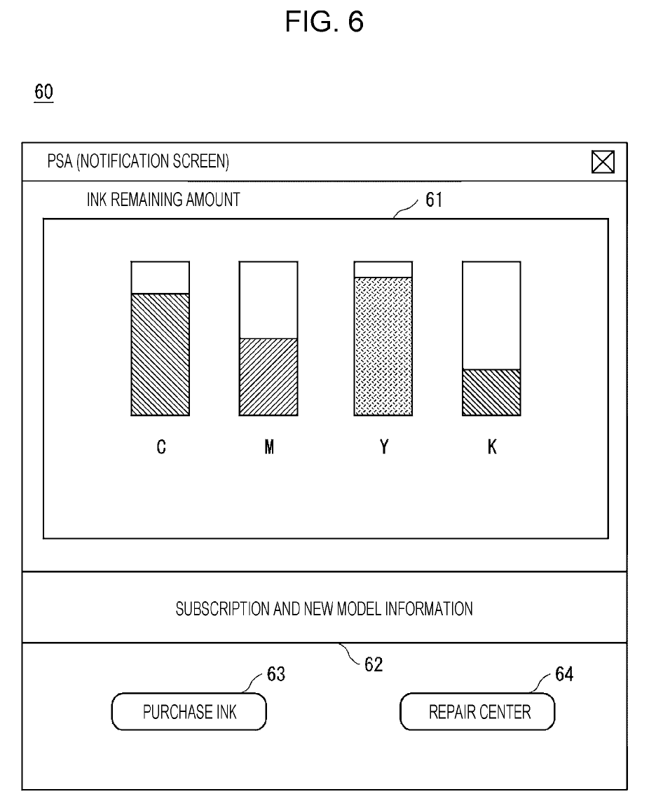

Next, with reference to FIGS. 3 to 6, a more specific example of the above-described processing example of the information processing apparatus 10 will be described together with a processing example of the entire printing system 100. FIG. 3 is a sequence diagram for explaining a processing example in the printing system 100. FIG. 4 is a sequence diagram for explaining a processing example subsequent to FIG. 3. FIG. 5 is a sequence diagram for explaining another processing example subsequent to FIG. 3. FIG. 6 is a diagram illustrating an example of a user interface image displayed in the processing example of FIG. 3.

The example in which the print control program for performing the above-described first acquisition processing, second acquisition processing, third acquisition processing, and display processing is installed in the vendor support app 17 will be given in the following description as well.

A flow of displaying, as the vendor guide information, a notification screen from the vendor in a print setting screen is as illustrated in FIG. 3, for example. Specifically, first, a user U provides an instruction to display the notification screen from the vendor on the vendor support app 17 from the operation section 14 (Step S11).

Next, the vendor support app 17 performs IPP communication with the main body of the printer A(31) and provides, to the printer A(31), a request for apparatus information including ink remaining amount information, model number information of the model, and serial number information from the printer A(31) (Step S12). The vendor support app 17 acquires the apparatus information from the printer A(31) returning the apparatus information (Step S13). Note that the ink remaining amount information can be information indicating the amount of remaining liquid ink in a case where the printer A(31) is of an ink jet type or can be information indicating the amount of remaining toner ink in a case where the printer A(31) is of a laser type.

Then, the vendor support app 17 provides, to the OS 16, a request for region information and language information (Step S14). The vendor support app 17 acquires the region information and the language information from the OS 16 responding to the request (Step S15). Note that Steps S12 and S13 and Steps S14 and S15 may be performed in any order.

Next, the vendor support app 17 displays the ink remaining amount information included in the acquired apparatus information on the notification screen from the vendor in accordance with user information indicated by the region information and the language information (Step S16).

The notification screen is, for example, a portion corresponding to an ink remaining amount image 61 indicating the ink remaining amount of each color in a UI image 60 illustrated in FIG. 6. The UI image 60 including the ink remaining amount image 61 is a UI image including vendor guide information, and it is only necessary for the UI image 60 to be displayed on the display section 15 as a pop-up image.

Then, the vendor support app 17 transmits the acquired apparatus information including at least the model number information of the printer A(31) and the region information and the language information acquired from the OS 16 to the server 20 (Step S17). The vendor support app 17 acquires subscription information and new model information from the server 20 transmitting the subscription information and the new model information to the vendor support app 17 in response to this (Step S18). In Step S18, it is only necessary for the server 20 to return the subscription information and the new model information in accordance with the received region information and language information.

Next, the vendor support app 17 displays the acquired subscription information and new model information on the notification screen from the vendor (Step S19). This notification screen is, for example, the UI image 60 illustrated in FIG. 6 and is a UI image in accordance with the user information indicated by the region information and the language information. The UI image 60 is a UI image including the vendor guide information, and it is only necessary for the UI image 60 to be displayed on the display section 15 as a pop-up image.

The UI image 60 can include the above-described ink remaining amount image 61, a subscription/new model information button 62, an ink purchase button 63, and a repair center button 64. For example, the ink remaining amount image 61 and the buttons 62 to 64 may be arranged in advance. The vendor support app 17 may then change the ink remaining amount image 61 in accordance with the acquired ink remaining amount information and change link destinations of the buttons 62 to 64 based on the information received from the server 20. Note that although FIG. 3 illustrates an example in which the UI image 60 with the buttons 62 to 64 added thereto is displayed after the ink remaining amount image 61 is displayed, the display timings may be the same.

Each of the buttons 62 to 64 is a button that can be selected by the user U using the operation section 14. Therefore, it is possible to access a website that introduces the subscription information and the new model information and to display the website by the subscription/new model information button 62 being selected. It is a matter of course that the subscription/new model information button 62 may be divided into a subscription information button and a new model information button and may be displayed so as to be selectable by the user.

Here, since the subscription information is information that the vendor support app 17 has received from the server 20 based on the apparatus information, the subscription information can be information for guiding rental of a printer other than the printer A(31), for example. In addition, since the new model information is information that the vendor support app 17 has received from the server 20 based on the apparatus information, it is possible for the new model information not to include information regarding printers of older models than the printer A(31), for example.

A flow of processing in a case where the ink purchase button 63 is selected by the user U in the UI image 60 is as illustrated in FIG. 4, for example. Note that FIG. 4 illustrates Step S19 of FIG. 3 and the following steps.

Specifically, first, the user U presses, that is, selects the ink purchase button 63 in the UI image 60 through the operation section 14 (Step S20). In response to this operation, the vendor support app 17 transmits, to the server 20, the apparatus information including at least the model number information of the printer A(31) and the region information and the language information acquired from the OS 16 (Step S21). The vendor support app 17 acquires ink purchase site information from the server 20 extracting the ink purchase site information corresponding to the apparatus information, the region information, and the language information from the DB 21 and returning the ink purchase site information (Step S22).

The ink purchase site information may be information for access to the ink purchase site. Next, the vendor support app 17 displays the acquired ink purchase site information on the notification screen from the vendor (Step S23). Although exemplary illustration of the notification screen is omitted, the notification screen may be access information itself that enables access to the ink purchase site by user selection. Alternatively, instead of the notification screen, the site as a result of accessing the ink purchase site may be displayed and presented to the user U in Step S23.

In addition, consumables other than ink are also mounted or used in the printer. Therefore, the vendor support app 17 may acquire information indicating remaining amounts of other consumables or remaining periods for which other consumables can be used, in addition to the ink remaining amount or instead of the ink remaining amount information. Then, the vendor support app 17 may display, as the vendor guide information, purchase site information and maintenance request site information indicating sites to be contacted for maintenance for above-described other consumables. Above-described other consumables may also include printing media such as printing paper and printing roll paper.

A flow of processing in a case where the repair center button 64 is selected by the user U in the UI image 60 is as illustrated in FIG. 5, for example. Note that FIG. 5 illustrates Step S19 of FIG. 3 and the following steps.

Specifically, the user U presses, that is, selects the repair center button 64 in the UI image 60 through the operation section 14 first (Step S30). In response to this operation, the vendor support app 17 transmits, to the server 20, the apparatus information including at least the serial number information of the printer A(31) and the region information and the language information acquired from the OS 16 (Step S31). The apparatus information may also include model number information. The vendor support app 17 acquires repair center site information from the server 20 extracting the repair center site information corresponding to the apparatus information, the region information, and the language information from the DB 21 and returning the repair center site information (Step S32). The acquired repair center site information is information indicating the site of the repair center associated with the serial number indicated by the serial number information, and it is possible to perform the acquisition processing in Step S32 by associating the serial number information with the DB 21.

The repair center site information may be information for access to the repair center site. Next, the vendor support app 17 displays the acquired repair center site information on the notification screen from the vendor (Step S33). Although exemplary illustration of the notification screen is omitted, the notification screen may be access information itself that enables access to the repair center site by user selection. Alternatively, instead of the notification screen, the site as a result of accessing the repair center site may be displayed and presented to the user U in Step S33.

Although the example in which the repair center site is displayed is exemplified in FIG. 5, the subscription information or the new model information can be displayed on the display section 15 of the information processing apparatus 10 and can be presented to the user U in a similar procedure also in a case where the subscription/new model information button 62 is selected. The subscription information associated with the serial number information can include, for example, extended registration of a contract for the printer A(31) indicated by the serial number information. The new model information associated with the serial number information can include, for example, information regarding a successor of the printer A(31) indicated by the serial number information.

As described above, the apparatus information of the printer A(31) that the vendor support app 17 acquires from the printer A(31) and transmits to the server 20 can include the serial number information indicating the serial number of the printer A(31). The vendor guide information can be information associated with the serial number information. In this manner, in the present embodiment, it is possible to display the repair center site, the subscription information, and the new model information corresponding to the serial number indicated by the serial number information.

Furthermore, in the present embodiment, instead of the subscription information and the new model information or in addition to the subscription information and the new model information, information useful for the user U, such as campaign information indicating a campaign provided by the vendor, may be provided in a similar manner.

### Effects of Present Embodiment

As described above, in the printing system 100, the print control program exemplified by the vendor support app 17 acquires the apparatus information from the printer and acquires at least either the region information or the language information from the OS 16. Also, in the printing system 100, the vendor guide information based on the apparatus information and at least either the region information or the language information is acquired from the server 20, and the vendor guide information that matches the user U is displayed. The vendor guide information that matches the user U can be vendor guide information that is different for each printer model or for each user U of the information processing apparatus 10.

Therefore, according to the present embodiment, it is possible to display the vendor guide information as detailed information regarding the printer in an environment in which the print processing using the general-purpose printer driver 16d is performed. In particular, according to the present embodiment, since the vendor guide information to be displayed is based on at least either the region information or the language information, the vendor guide information can be displayed as information that matches settings of the information processing apparatus 10 by the user U.

For example, according to the present embodiment, it is possible for the user U to display the vendor guide information for the printer in use only by installing the vendor support app 17, and therefore, it is possible to state that convenience can be improved. More specifically, the user U can easily purchase the vendor-provided ink by displaying the notification screen from the vendor. In addition, since the repair center site associated with the serial number can be displayed in the present embodiment, the user U does not need to do a work of checking the serial number and a work of inputting the serial number and can easily make an inquiry to the repair center.

In addition, according to the present embodiment, the vendor can easily prompt the user U to purchase the vendor-provided ink, make replacement with or additional purchase of a new model, register a subscription, and the like, which leads to sales promotion.

### Second Embodiment

As a second embodiment, another processing example in a printing system 100 will be described. Although the printing system according to the present embodiment is a partial modification of the printing system 100 of FIG. 1 and only the modifications will be described with reference to FIG. 1 for the configuration, various examples described in the first embodiment can also be applied. Hereinafter, a processing example of an information processing apparatus 10 according to the present embodiment will be described together with a specific processing example of the entire printing system 100.

### Specific Processing Example of Printing System 100

In the present embodiment, it is assumed that vendor guide information includes purchase site information indicating an ink purchase site which is a site for purchasing ink for a printer A(31). The purchase site information indicates the ink purchase site information illustrated in FIG. 4. Note that although an example in which printing is performed by the printer A(31) will be described similarly to the first embodiment, the processing may be performed by a printer B(32) or a printer C(33) instead.

The display processing according to the present embodiment includes processing of displaying the ink purchase site information in a case where the amount of ink remaining in the printer A(31) is equal to or less than a first predetermined threshold value. Although such display can be executed in a scene in which a notification screen as described in the first embodiment is displayed, such display may be executed at the time of completion of printing. Such an example will be described below.

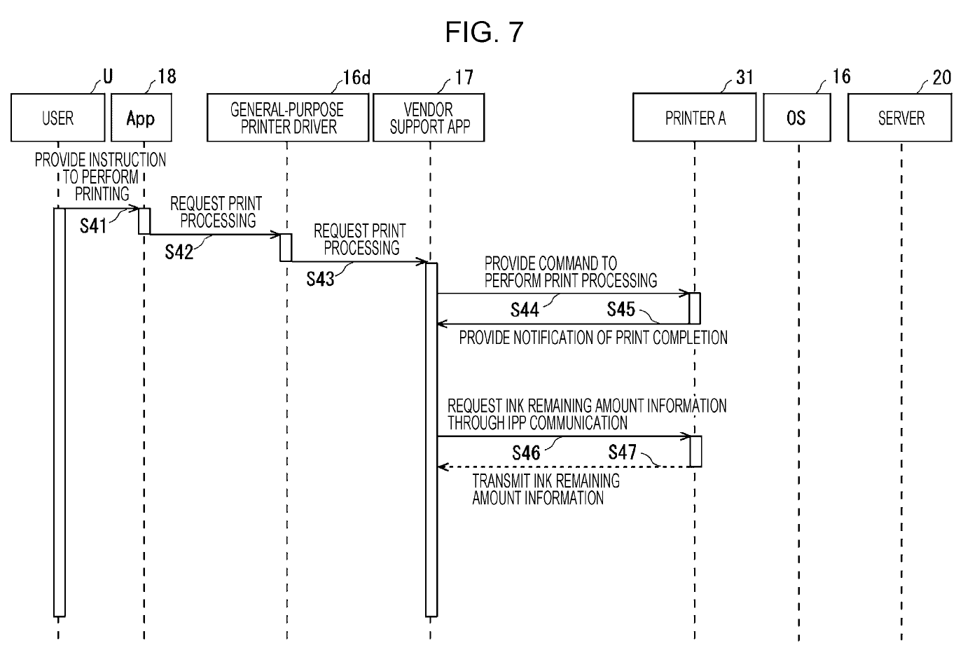

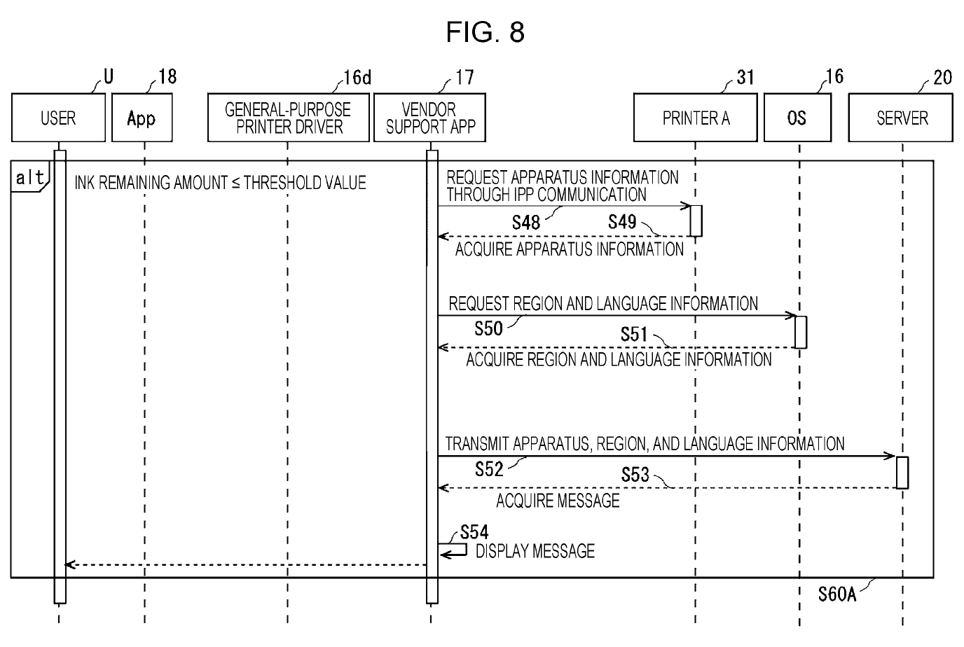

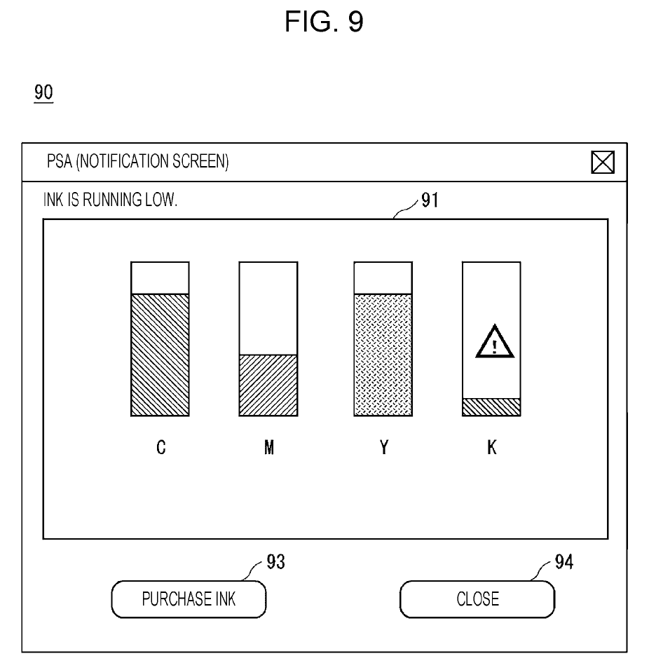

An example of processing for displaying such purchase site information at the time of completion of printing will be described with reference to FIGS. 7 to 9. FIG. 7 is a sequence diagram for explaining a processing example in the printing system 100 including the information processing apparatus 10 according to the present embodiment. FIG. 8 is a sequence diagram for explaining a processing example subsequent to FIG. 7. FIG. 9 is a diagram illustrating an example of a UI image displayed in the processing example of FIG. 8.

A flow of displaying the notification screen from the vendor at the time of completion of printing as vendor guide information is as illustrated in FIGS. 7 and 8, for example. Specifically, first, the user U performs, through an operation section 14, a user operation of providing an instruction to print a file opened in any app 18, which has been installed in the information processing apparatus 10 in an executable manner, by the printer A(31) from the app 18 (Step S41).

The app 18 having received the user operation transmits a print processing request to a general-purpose printer driver 16d (Step S42). The general-purpose printer driver 16d having received the print processing request passes the print processing request to the vendor support app 17 (Step S43). The vendor support app 17 having received the print processing request transmits the above-described print processing command for the file to the printer A(31) (Step S44) and receives a print completion notification from the printer A(31) (Step S45). Note that the print processing command may be executed via the general-purpose printer driver 16d.

Next, the vendor support app 17 performs IPP communication with the main body of the printer A(31) in response to the print completion notification and provides, to the printer A(31), a request for ink remaining amount information from the printer A(31) (Step S46). The vendor support app 17 acquires the ink remaining amount information from the printer A(31) returning the ink remaining amount information (Step S47).

The vendor support app 17 having acquired the ink remaining amount information determines whether or not the ink remaining amount indicated by the acquired ink remaining amount information is equal to or less than the first predetermined threshold value (determination step in Step S60A). Note that it is only necessary to perform threshold value determination for the ink remaining amount of each color, and here, it is only necessary to determine whether or not there is ink of even one color, the remaining amount of which is equal to or less than the threshold value. The vendor support app 17 may end the processing in a case where the ink remaining amount is greater than the threshold value.

On the other hand, in a case where the amount of ink remaining in the printer A(31) is equal to or less than the threshold value, IPP communication with the main body of the printer A(31) is performed, and a request for apparatus information including at least model number information from the printer A(31) is provided to the printer A(31) (Step S48). The vendor support app 17 acquires the apparatus information from the printer A(31) returning the apparatus information (Step S49).

Then, the vendor support app 17 provides a request for region information and language information from the OS 16 (Step S50). The vendor support app 17 acquires the region information and the language information from the OS 16 responding to the request (Step S51). Note that Steps S48 and S49 and Steps S50 and S51 may be performed in any order.

Then, the vendor support app 17 transmits the acquired apparatus information including at least the model number information of the printer A(31) and the region information and the language information acquired from the OS 16 to the server 20 (Step S52). From the server 20 transmitting a message from the vendor to the vendor support app 17 in response to this, the vendor support app 17 acquires the message (Step S53). This message includes ink purchase site information and may also include a message indicating that the remaining ink is running low.

Next, the vendor support app 17 displays the acquired message including the ink purchase site information on the notification screen at the time of completion of printing (Step S54). The notification screen is, for example, a UI image 90 illustrated in FIG. 9, which is a UI image in accordance with user information indicated by the region information and the language information. The UI image 90 is a UI image including the vendor guide information, and it is only necessary for the UI image 90 to be displayed on the display section 15 as a pop-up image.

The UI image 90 can include an ink remaining amount image 91 with an attached mark for calling attention to ink of a color, the remaining amount of which is equal to or less than a threshold value, an ink purchase button 93, and a close button 94. For example, the ink remaining amount image 91, the ink purchase button 93, and the close button 94 may be arranged in advance. Then, the vendor support app 17 may change the ink remaining amount image 91 in accordance with the acquired ink remaining amount information and change the link destination of the ink purchase button 93 based on the information received from the server 20. As described above, the vendor support app 17 may display the message including the ink purchase site information acquired in Step S53 together with the ink remaining amount acquired in Step S47 or Step S53.

In a case where the close button 94 is selected in the UI image 90, the vendor support app 17 may close the UI image 90 and end the print processing. The vendor support app 17 may cause the ink purchase site to be displayed, close the UI image 90, and end the print processing in a case where the ink purchase button 93 is selected in the UI image 90 as well.

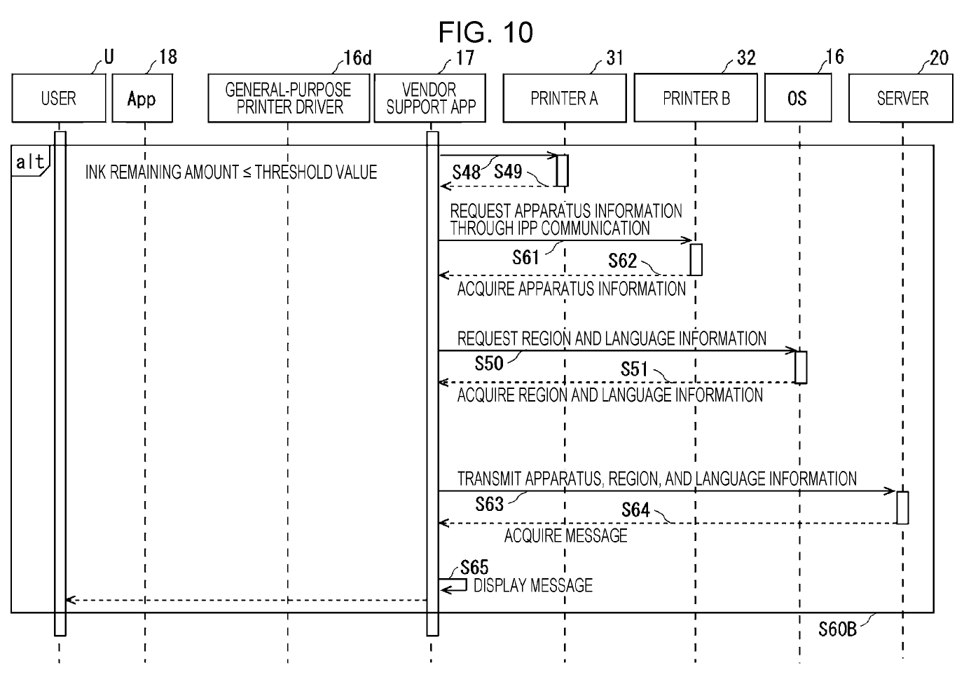

Next, another example of the display processing will be described with reference to FIG. 10. FIG. 10 is a sequence diagram for explaining another processing example subsequent to FIG. 7.

The above-described display processing may include processing of displaying the purchase site information in a case where the amount of ink remaining in another printer B(32) that is connected to the information processing apparatus 10 and uses ink that is purchasable from the above-described ink purchase site for the printer A(31) is equal to or less than a second predetermined threshold value. Note that another printer may be the printer C(33) or may be the printer B(32) and the printer C(33).

The second predetermined threshold value may be a value that is larger than the first predetermined threshold value as the ink remaining amount or as a percentage of the ink remaining amount with respect to the full amount. In this manner, it is possible to recommend purchase of the ink at the time of using the printer A(31) before the amount of ink remaining in the printer B(32) becomes equal to or less than the first predetermined threshold value.

Such display processing can be executed by performing processing in Step S60B in FIG. 10 instead of Step S60A in FIG. 8, for example.

First, the vendor support app 17 executes the processing in Steps S48 and S49. Then, the vendor support app 17 performs IPP communication with the main body of the printer B(32) in a similar manner and provides, to the printer B(32), a request for apparatus information including at least model number information and ink remaining amount information from the printer B(32) (Step S61). The vendor support app 17 acquires the apparatus information of the printer B(32) from the printer B(32) returning the apparatus information (Step S62).

Next, the vendor support app 17 executes the processing in Steps S50 and S51. Note that Steps S48 and S49, Steps S61 and S62, and Steps S50 and S51 may be performed in any order.

Then, the vendor support app 17 transmits the acquired apparatus information including at least the model number information of the printer A(31) and apparatus information including at least the model number information of the printer B(32), and the region information and the language information acquired from the OS 16 (Step S63). The transmission destination is the server 20.

Although not illustrated in FIG. 10 due to space limitations, the vendor support app 17 determines whether or not the ink remaining amount indicated by the ink remaining amount information acquired in Step S62 is equal to or less than the second predetermined threshold value, which is a threshold value. Note that it is only necessary to perform threshold value determination for the ink remaining amount of each color in this case as well, and here, it is only necessary to determine whether or not there is ink of even one color, the remaining amount of which is equal to or less than the second predetermined threshold value. In a case where the amount of ink remaining in the printer B(32) is greater than the second predetermined threshold value, the vendor support app 17 does not transmit the apparatus information of the printer B(32) in Step S63. On the other hand, in a case where the amount of ink remaining in the printer B(32) is equal to or less than the second predetermined threshold value, the vendor support app 17 may also transmit the apparatus information of the printer B(32) to the server 20.

From the server 20 transmitting a message from the vendor to the vendor support app 17 in response to the transmission in Step S63, the vendor support app 17 acquires the message (Step S64).

This message includes ink purchase site information and may also include a message indicating that the remaining ink is running low. Here, in a case where the amount of ink remaining in the printer B(32) is greater than the second predetermined threshold value, the vendor support app 17 can acquire the message indicating that the ink remaining in the printer A(31) is running low.

On the other hand, in a case where the amount of ink remaining in the printer B(32) is equal to or less than the second predetermined threshold value, the vendor support app 17 can acquire a message indicating that the ink remaining in both the printer A(31) and the printer B(32) is running low. The message may include a message indicating that purchase of the ink for the printer B(32) is also recommended at the same time. However, in this case, the server 20 returns the message including the ink purchase site information of the printer B(32) with reference to the DB 21, and the vendor support app 17 acquires the message. In a case where the ink purchase sites for the printer A(31) and the printer B(32) are the same, it is only necessary for one piece of ink purchase site information to be able to be acquired.

Next, the vendor support app 17 displays the acquired message including the ink purchase site information on the notification screen at the time of completion of printing (Step S65). The notification screen may be the same as the UI image 90 illustrated in FIG. 9 in a case where the amount of ink remaining in the printer B(32) is greater than the second predetermined threshold value, for example.

On the other hand, in a case where the amount of ink remaining in the printer B(32) is equal to or less than the second predetermined threshold value, the notification screen may include an ink remaining amount image for the printer B(32) similar to the ink remaining amount image 91 in the UI image 90. In a case where the ink purchase sites for the printer A(31) and the printer B(32) are different from each other, the notification screen may include the ink purchase site information for both the printers in the UI image 90.

Note that although the processing example at the time of completion of printing has been described for the processing of the present embodiment, the processing of the present embodiment can also be applied to display of the notification screen in a similar manner.

### Effects of Present Embodiment

As described above, the printing system 100 according to the present embodiment performs the processing of displaying the ink purchase site information in a case where the amount of ink remaining in the printer is equal to or less than the first predetermined threshold value. For example, in a case where the ink remaining amount is equal to or less than the threshold value at the time of completion of printing or the like, a message indicating that the ink remaining amount is equal to or less than the threshold value, the ink remaining amount, and the ink purchase button are displayed in the present embodiment. Therefore, according to the present embodiment, the user can recognize that the ink remaining amount is equal to or less than the threshold value and can smoothly purchase the vendor-provided ink, in addition to the effects of the first embodiment.

In the present embodiment, information regarding other printers which are not being used for printing is also acquired and provided to the user, and the user can thus purchase the vendor-provided ink at the same time. Therefore, there is a possibility that the user can save time and effort for separately performing a purchase procedure, can easily notice a situation in which the user should purchase the product, can pay no shipping charge due to the simultaneous purchase, and can order the product at a lower unit price as a result of providing such information in the present embodiment. Furthermore, information regarding other printers that are not being used for printing is also acquired and provided to the user, which leads to sales promotion for the vendor.

### Other Modifications

The present disclosure is not limited to the above-described embodiments and can be appropriately modified without departing from the gist. For example, the system configuration of the printing system, the configuration of each apparatus constituting the printing system, the configuration of each program included in each apparatus, the processing procedure of each apparatus, and the like are not limited to those illustrated.

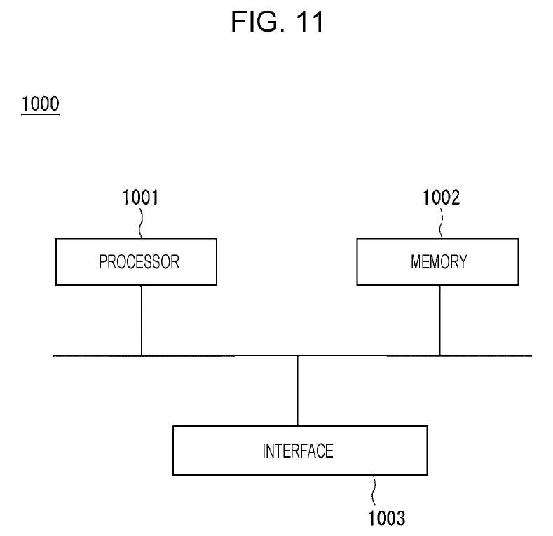

Furthermore, each of the apparatuses included in the printing system according to the above-described embodiments may have, for example, the following hardware configuration. Here, the information processing apparatus, the server, and each printer can be listed as each apparatus in the example of FIG. 1. FIG. 11 is a diagram illustrating an example of the hardware configuration of an apparatus.

An apparatus 1000 illustrated in FIG. 11 can include a processor 1001, a memory 1002, and an interface 1003. The interface 1003 can include, for example, a communication interface and an interface with an input/output device or the like, which are necessary depending on the apparatus.

The processor 1001 may be, for example, a CPU, a GPU, a micro processor unit (MPU) which is also referred to as a microprocessor, or the like. The processor 1001 may include a plurality of processors. The memory 1002 is configured by, for example, a combination of a volatile memory and a nonvolatile memory. Functions of each apparatus are implemented by the processor 1001 reading a program stored in the memory 1002 and executing the program while exchanging necessary information via the interface 1003.

In addition, the above-described program includes a command group (or software code) for causing a computer to perform one or more of the functions described in the embodiments in a case where the program is read by the computer. The program may be stored in a non-transitory computer-readable medium or a tangible storage medium. By way of non-limiting examples, the computer-readable medium or the tangible storage medium includes a random-access memory (RAM), a read-only memory (ROM), a flash memory, a solid-state drive (SSD), and other memory technologies. Also, by way of non-limiting examples, the computer-readable medium or the tangible storage medium includes a CD-ROM, a digital versatile disc (DVD), a Blu-ray (registered trademark) disc, and other optical disc storages, a magnetic cassette, a magnetic tape, a magnetic disk storage, and other magnetic storage devices. The program may be transmitted on a transitory computer-readable medium or a communication medium. By way of non-limiting example, the transitory computer-readable medium or the communication medium includes propagated signals in electrical, optical, acoustical, or other forms. Furthermore, the program is included in a program product.

Although the present disclosure has been described with reference to the above-described embodiments, the present disclosure is not limited only to the configurations described in the above-described embodiments, and it goes without saying that the present disclosure includes various modifications, corrections, and combinations that can be made by those skilled in the art within the scope of the claims of the present application.

What is claimed is:

1. A non-transitory computer-readable storage medium storing a print control program for extending a general-purpose printer driver, the print control program causing
a computer to execute:
first acquisition processing of acquiring, from a printer, apparatus information of the printer;
second acquisition processing of acquiring, from an operating system, at least either region information or language information;
third acquisition processing of transmitting the apparatus information and at least either the region information or the language information to a server connected to the computer and acquiring, from the server, vendor guide information regarding a vendor of the printer; and
display processing of displaying the vendor guide information.

2. The non-transitory computer-readable storage medium storing a print control program according to claim 1, wherein the print control program is a print support application.

3. The non-transitory computer-readable storage medium storing a print control program according to claim 1, wherein
the apparatus information includes serial number information indicating a serial number of the printer, and
the vendor guide information is information associated with the serial number information.

4. The non-transitory computer-readable storage medium storing a print control program according to claim 1, wherein
the vendor guide information includes purchase site information indicating a site where ink for the printer is purchased, and
the display processing includes processing of displaying the purchase site information in a case where an amount of ink remaining in the printer is equal to or less than a first predetermined threshold value.

5. The non-transitory computer-readable storage medium storing a print control program according to claim 4, wherein
the display processing includes the processing of displaying the purchase site information in a case where an amount of ink remaining in another printer that is connected to the computer and being purchasable from the site is equal to or less than a second predetermined threshold value.

6. An information processing apparatus comprising:
a general-purpose printer driver that is standard with an operating system;
a first acquisition processing section that acquires, from a printer, apparatus information of the printer;
a second acquisition processing section that acquires, from the operating system, at least either region information or language information;
a third acquisition processing section that transmits the apparatus information and at least either the region information or the language information to a server connected to the information processing apparatus and acquires, from the server, vendor guide information regarding a vendor of the printer; and
a display processing section that displays the vendor guide information.

7. An information processing method comprising causing a computer to execute:
first acquisition processing of acquiring, from a printer, apparatus information of the printer;
second acquisition processing of acquiring at least either region information or language information from an operating system in which a general-purpose printer driver is included or to which the general-purpose printer driver is attached;
third acquisition processing of transmitting the apparatus information and at least either the region information or the language information to a server connected to the computer and acquiring, from the server, vendor guide information regarding a vendor of the printer; and
display processing of displaying the vendor guide information.
